(19) United States
(12) Patent Application Publication
(10) Pub. No.: US 2005/0013904 A1
(43) Pub. Date: Jan. 20, 2005

(54) Food product arrangement

(76) Inventor: Josh Schreider, Big Bear Lake, CA (US)

Correspondence Address: DON B. FINKELSTEIN, ESQ.;LAW OFFICES OF DON FINKELSTEIN, SUITE 216, 3858 CARSON STREET, TORRANCE, CA, 90503, US

(21) Appl. No.: 10/623,489

(22) Filed: Jul. 18, 2003

(51) Int. Cl. A23G 3/00

(52) U.S. Cl. 426/94

(57) ABSTRACT

A food product composed of a first elongated dough member formed into the shape of a pretzel and defining three open spaces and a second elongated dough member formed into a spiral and positioned into at least one of said open spaces and the first dough member is pretzel dough and the second dough member is cinnamon bun dough.

### BACKGROUND OF THE INVENTION

1. Field of the Invention

This invention relates to the food product art and more particularly to a snack food product combining a pretzel type snack food with a cinnamon bun type snack food.

2. Description of the Prior Art

Snack foods are one of the common type of food products enjoyed by many people as between meal snacks, with meals or in place of meals, as the case may be. Among the many varieties of snack foods are pretzels and cinnamon buns. Both of these types of snack foods have in the past and now are two of the most popular snack foods demanded by the purchasing public. Many shopping malls, strip malls, shopping centers, discount merchandisers and the like often feature separate stores or locations which dispense pretzels and others which dispense cinnamon buns.

However, there has not heretofore been a single food product which combines the taste composition and configuration of both a pretzel and a cinnamon bun.

### SUMMARY OF THE INVENTION

Accordingly, it is an object of the present invention to provide an improved snack food.

It is another object of the present invention to provide a snack food having the configuration and composition of both a pretzel and a cinnamon bun.

It is yet another object of the present invention to provide an improved snack food that may be economially fabricated and configured in the conventional shapes of both a cinnamon bun and a pretzel.

The above and other objects of the present invention are achieved, in preferred embodiments of the invention, by providing a first elongated dough member which has a first preselected composition such aa a pretzel dough and is formed into the conventional pretzel shape in which there are provided three openings between adjacent portions of the pretzel. It will be understood that other configurations of the first elongated dough member may be utilized in the practice of the present invention. The preferred embodiments described herein are described with reference to the conventional pretzel configuration for convenience of description.

A second elongated dough member is also provided and the second elongated dough member may have a second composition which maybe, for example, be a cinnamon bun dough. The second elongated dough member is formed in the configuration of a spiral and is positioned within one of the openings formed by the pretzel configuration of the first elongated dough member. The second elongated dough member is retained in the one of the openings of the first elongated dough member's pretzel configuration by frictional forces or by adhesion to the adjacent portions of the first elongated dough member. The adhesion may be accomplished by surface treatment such as the based coating often employed on cinnamon buns or any other desired type of coating utilized on cinnamon buns.

In other embodiments of the present invention there may be provided both a second elongated dough member and a third elongated dough member positioned, individually, in a first and a second of the openings provided by the pretzel configuration of the first elongated dough member. The third elongated dough member may have the same cinnamon bun composition as the second elongated dough member or, alternatively, the composition of the first elongated dough member.

In other embodiments of the present invention there may be provided both a second elongated dough member, a third elongated dough member and a fourth elongated dough member positioned in, respectively the first, second and third openings defined by the pretzel configuration of the first elongated dough member. At least one of the first, second and third elongated dough members is composed of a cinnamon bun dough to provide the desired combination of a pretzel and a cinnamon bun.

### BRIEF DESCRIPTION OF THE DRAWING

The above and other objects of the present invention my be more fully understood from the following detailed description taken together with the accompanying drawing wherein similar reference characters refer to similar elements throughout and in which:

FIG. 1 illustrates a first embodiment of the present invention;

FIG. 2 illustrates a second embodiment of the present invention;

FIG. 3 illustrates a third embodiment of the present invention;

FIG. 4 illustrates a fourth embodiment of the present invention;

FIG. 5 illustrates a fifth embodiment of the present invention;

FIG. 6 illustrates a sixth embodiment of the present invention; and,

FIG. 7 illustrates a seventh embodiment of the present invention.

### DESCRIPTION OF THE PREFERRED EMBODIMENTS

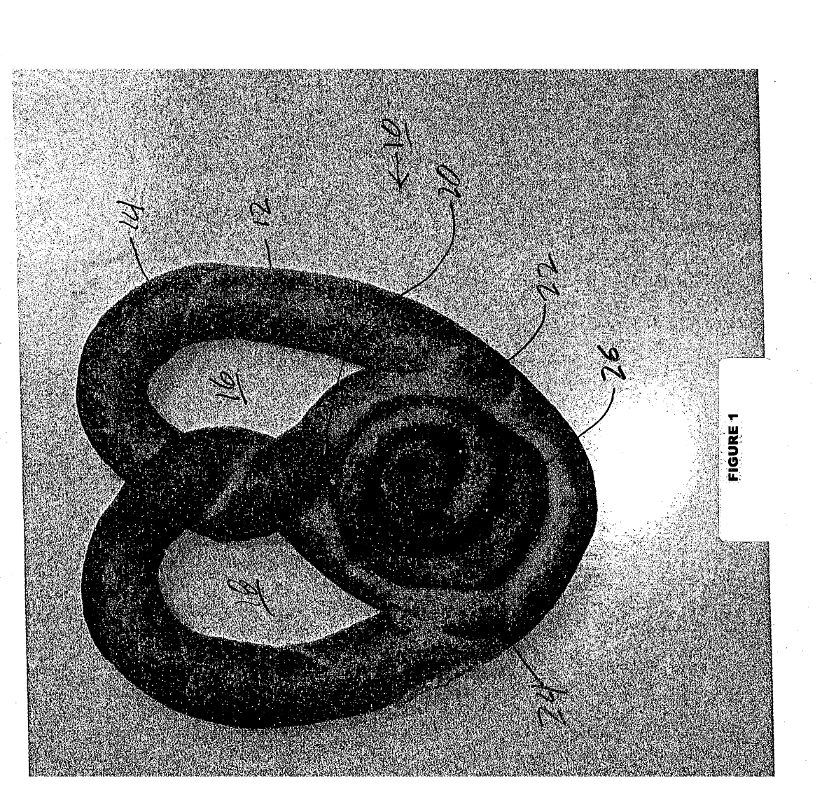

Referring now to the drawing, there is illustrated in FIG. 1 a first embodiment, generally designated 10 of the present invention. The embodiment 10 is a food product, generally designated 12. The food product 12 is made from a first elongated dough member 14. The first elongated dough member 14 has a first preselected composition which may be a pretzel dough. The first elongated dough member 14 is made into the conventional pretzel configuration to define three openings 16, 18 and 20 between portions of the first elongated dough member 14. The first elongated dough member 14 has a first end 22 and a second end 24.

Positioned within opening 22 is a second elongated dough member 26 having a second preselected composition. The second preselected composition may be a cinnamon bun composition. The second elongated dough member is formed into a spiral configuration for nesting in the opening 20. The second elongated dough member 26 may be retained in the opening 20 by surface treatment such as by a sugar type coating thereon and/or by frictional forces between the first elongated dough member 14 and the second elongated dough member 26.

In a modified form of the embodiment 10, the second elongated dough member may be made from the same pretzel dough composition as the first elongated dough member 14. As a further modification, if desired, to the embodiment 10, the first end 22, or the second end 24 of the first elongated dough member 14 may be further elongated and twisted into the spiral configuration shown for the second elongated dough member 26.

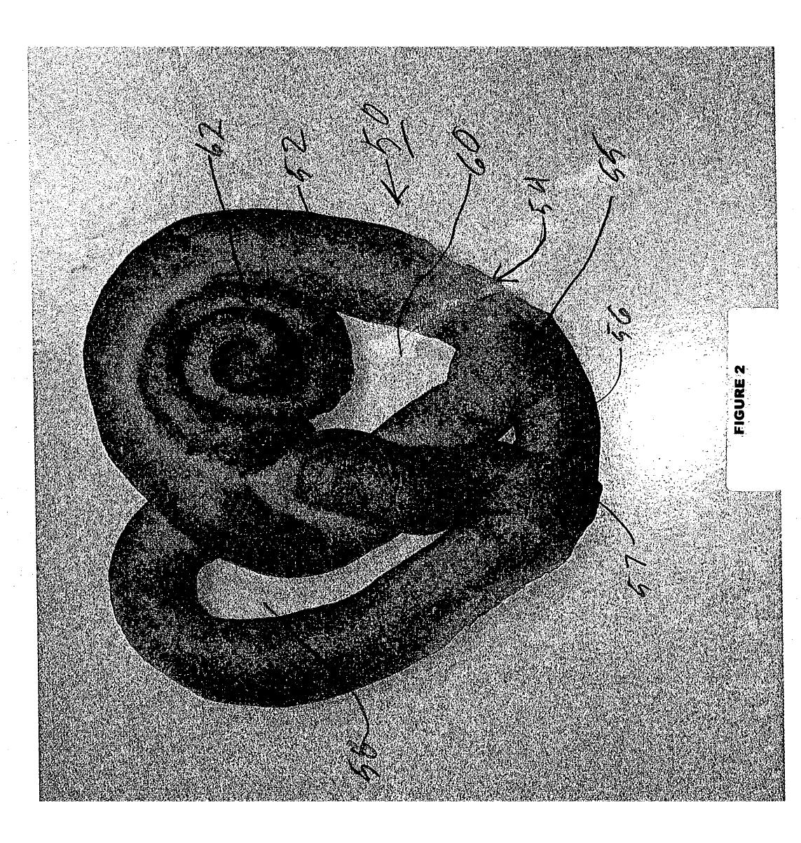

Referring now to FIG. 2, there is shown an embodiment 50 of the present invention which is similar to the embodiment 10 described above. There is provided a food product 52 having a first elongated dough member 54 similar to the first elongated dough member 14 described above which may be of a pretzel dough composition and is in the configuration of a pretzel and forms the three openings 56. 58 and 60. The first elongated dough member 54 also has a first end 55 and a second end 57. In the embodiment 50 there is a second elongated dough member 62 similar to the second elongated dough member 26 described above and is positioned in the opening 60. The second elongated dough member 62 may be of the same composition as the first elongated dough member 54 or a different composition such as a cinnamon dough. The second elongated dough member 62 may, if desired be formed from a further elongation of the first end 55 of the first elongated dough member 54.

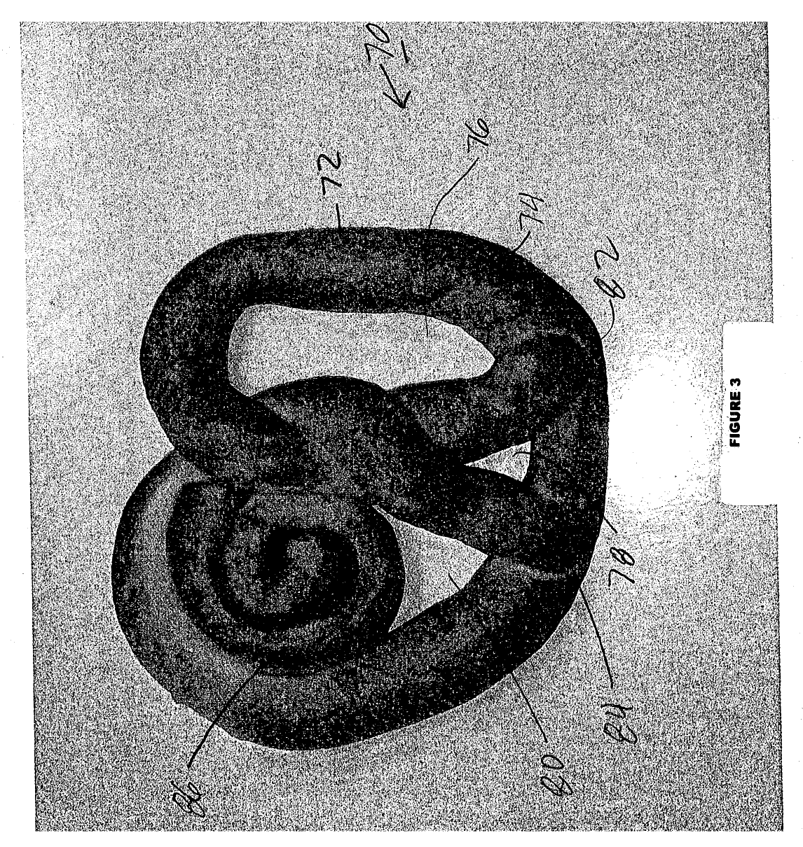

Referring now to FIG. 3, there is shown an embodiment 70 of the present invention which is similar to the embodiments 10 and 50 described above. There is provided a food product 72 having a first elongated dough member 74 similar to the first elongated dough member 14 described above which may be of a pretzel dough composition and is in the configuration of a pretzel and forms the three openings 76, 78 and 80. The first elongated dough member 74 also has a first end 82 and a second end 84. In the embodiment 70 there is a second elongated dough member 86 similar to the second elongated dough member 26 described above and is positioned in the opening 80. The second elongated dough member may be of the same composition as the first elongated dough member 54 or a different composition such as a cinnamon dough. The second elongated dough member 86 may, if desired be formed from a further elongation of the second end 84 of the first elongated dough member 54.

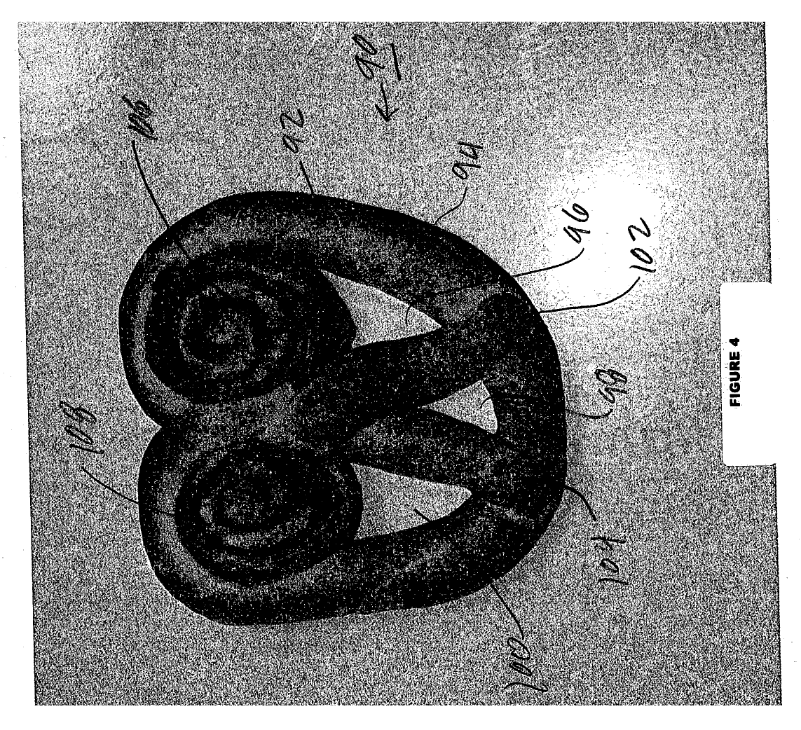

Referring now to FIG. 4, there is shown an embodiment 90 of the present invention which is similar to the embodiment 10, 50 and 70 described above. There is provided a food 92 having a first elongated dough member 94 similar to the first elongated dough member 14 described above which may be of a pretzel dough composition and is in the configuration of a pretzel and forms the three openings 96, 98 and 100. The first elongated dough member 94 also has a first end 102 and a second end 104. In the embodiment 90 there is a second elongated dough member 106 similar to the second elongated dough member 26 described above and is positioned in the opening 96. The second elongated dough member 106 may be of the same composition as the first elongated dough member 94 or a different composition such as a cinnamon dough. The second elongated dough member 106 may, if desired be formed from a further elongation of the first end 102 of the first elongated dough member 94. In the embodiment 90 there is also provided a third elongated dough member 108 which may be similar to the second elongated dough member 106. The third elongated dough member 108 may be of the same composition as the first elongated dough member 94 or a different composition such as a cinnamon dough. The third elongated dough member 108 may, if desired be formed from a further elongation of the second end 104 of the first elongated dough member 94.

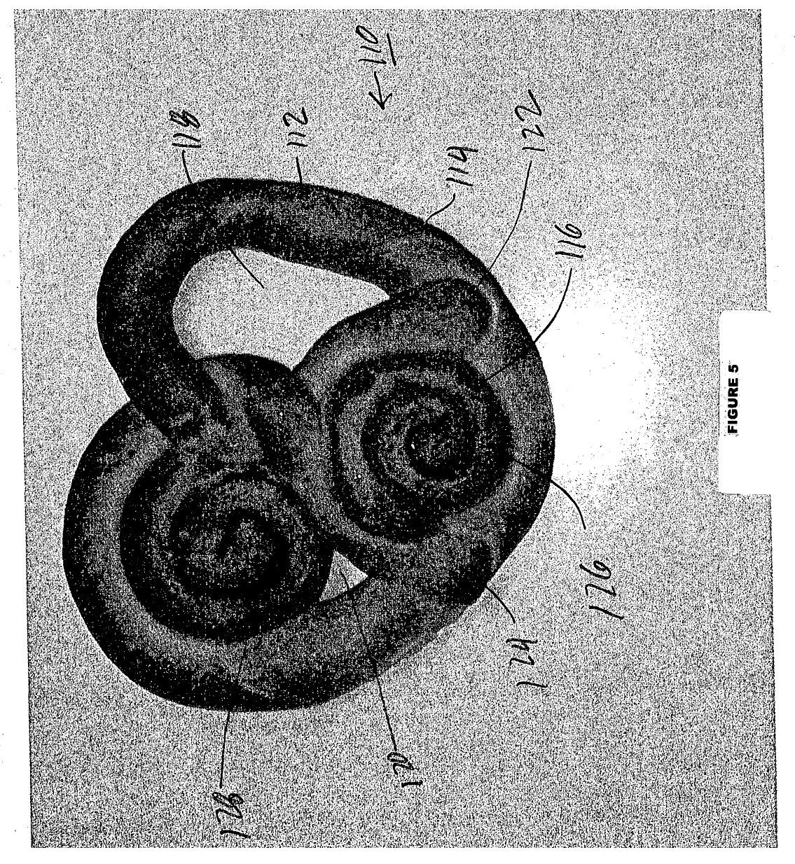

Referring now to FIG. 5, there is shown an embodiment 110 of the present invention which is similar to the embodiments 10, 50, 70 and 90 described above. There is provided a food 112 having a first elongated dough member 114 similar to the first elongated dough member 94 described above which may be of a pretzel dough composition and is in the configuration of a pretzel and forms the three openings 116, 118 and 120. The first elongated dough member. 114 also has a first end 122 and a second end 124. In the embodiment 110 there is a second elongated dough member 128 similar to the second elongated dough member 108 described above and is positioned in the opening 120. The second elongated dough member 128 may be of the same composition as the first elongated dough member 114 or a different composition such as a cinnamon dough. The second elongated dough member 128 may, if desired be formed from a further elongation of the second end 124 of the first elongated dough member 114. In the embodiment 110 there is also provided a third elongated dough member 108 which may be similar to the second elongated dough member 106. The third elongated dough member 126 which may be of the same composition as the first elongated dough member 114 or a different composition such as a cinnamon dough. The third elongated dough member 126 may, if desired be formed from a further elongation of the first end 122 or the second end 124 of the first elongated dough member 114.

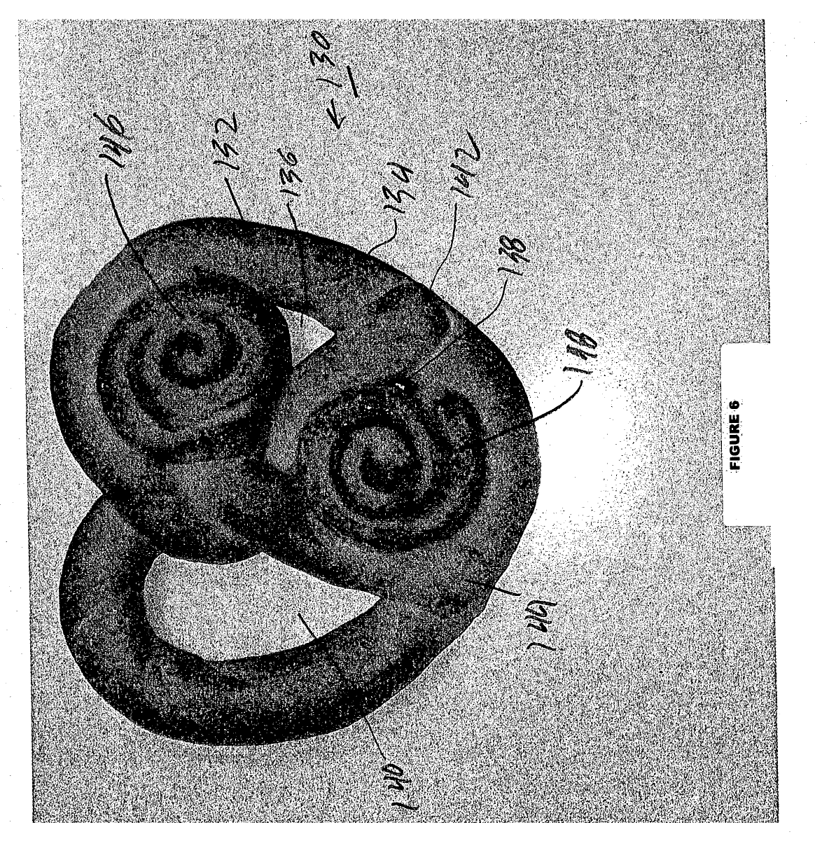

Referring now to FIG. 6, there is shown an embodiment 130 of the present invention which is similar to the embodiment 10, 50, 70, 90, and 110 described above. There is provided a food 132 having a first elongated dough member 134 similar to the first elongated dough member 114 described above which may be of a pretzel dough composition and is in the configuration of a pretzel and forms the three openings 136, 138 and 140. The first elongated dough member 134 also has a first end 142 and a second end 144. In the embodiment 130 there is a second elongated dough member 146 similar to the second elongated dough member 128 described above and is positioned in the opening 136. The second elongated dough member 146 may be of the same composition as the first elongated dough member 134 or a different composition such as a cinnamon dough. The second elongated dough member 146 may, if desired be formed from a further elongation of the second end 142 of the first elongated dough member 134. In the embodiment 130 there is also provided a third elongated dough member 148 which may be similar to the second elongated dough member 146. The third elongated dough member 148 which may be of the same composition as the first elongated dough member 134 or a different composition such as a cinnamon dough. The third elongated dough member 148 may, if desired be formed from a further elongation of the first end 142 or the second end 144 of the first elongated dough member 114.

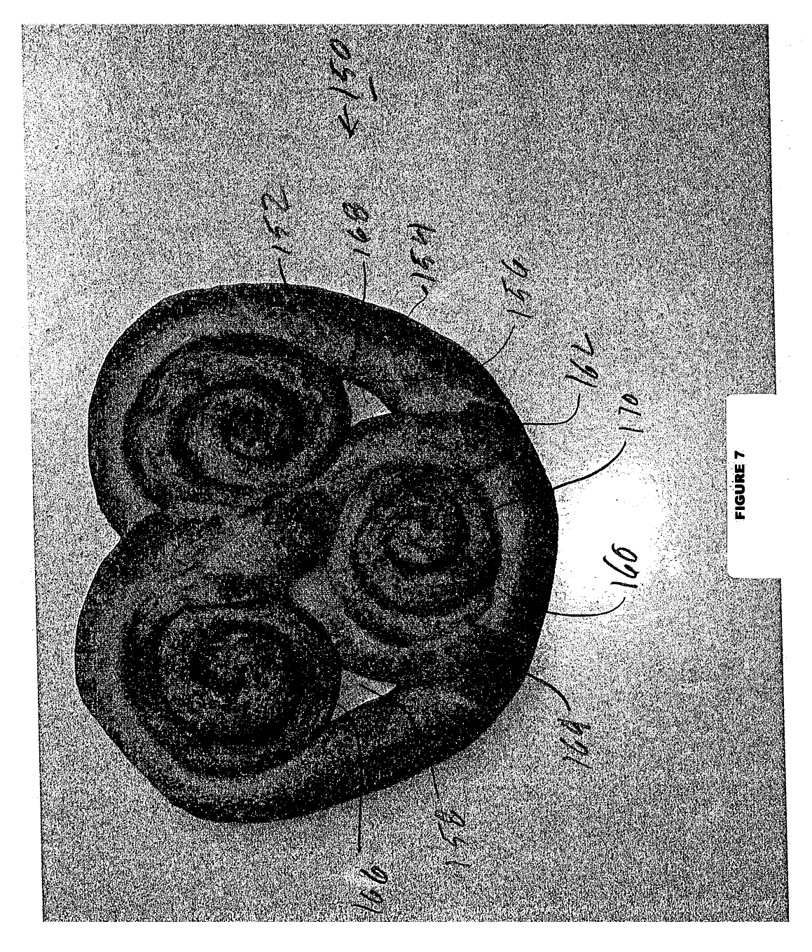

Referring now to FIG. 7, there is shown an embodiment 150 of the present invention which is similar to the embodiments 10, 50, 70, 90, 110 and 130 described above. There is provided a food product 152 having a first elongated dough member 154 similar to the first elongated dough member 134 described above which may be of a pretzel dough composition and is in the configuration of a pretzel and forms the three openings 156, 158 and 160. The first elongated dough member 154 also has a first end 162 and a second end 164. In the embodiment 150 there is a second elongated dough member 166 similar to the second elongated dough member 128 described above and is positioned in the opening 158. The second elongated dough member 166 may be of the same composition as the first elongated dough member 154 or a different composition such as a cinnamon dough. The second elongated dough member 166 may, if desired be formed from a further elongation of the second end 164 of the first elongated dough member 154. In the embodiment 150 there is also provided a third elongated dough member 108 which may be similar to the second elongated dough member 106. The third elongated dough member 168 which may be of the same composition as the first elongated dough member 154 or a different composition such as a cinnamon dough. The third elongated dough member 168 may, if desired be formed from a further elongation of the first end 162 of the first elongated dough member 114. In the embodiment 150 there is also provided a fourth elongated dough member 170 which may be similar to the second elongated dough member 166 and the third elongated dough member 168. The fourth elongated dough member 170 may be of the same composition as the first elongated dough member 154 or a different composition such as a cinnamon dough. The fourth elongated dough member 170 may, if desired be formed from a further elongation of the first end 162 or the second end 164 of the first elongated dough member 114.

Although specific embodiments of the present invention have been described above with reference to the various Figures of the drawing, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

1. A food product comprising, in combination:
a first elongated dough member having a first preselected composition and formed into a pretzel configuration having a plurality of open spaces between portions of the cylindrical dough, and said first elongated dough member having a first end and a second end;
a second elongated dough member having a second preselected composition and formed into a spiral configuration and positioned within a first of said plurality of open spaces of said first elongated dough member.

2. The arrangement defined in claim 1 wherein:
said first preselected composition of said first elongated dough member is different from said second preselected composition of said second elongated dough member.

3. The arrangement defined in claim 2 wherein:
said first preselected composition of said first elongated dough member is a pretzel dough composition; and, said second preselected composition of said second elongated dough member is a cinnamon bun dough composition.

4. The arrangement defined in claim 1 wherein:
said first preselected composition of said first elongated dough member is the same composition as said second preselected composition of said second elongated dough member; and,
said plurality of open spaces is three.

5. The arrangement defined in claim 4 wherein:
said first end of said first elongated dough member is formed into a spiral to define said second elongated dough member positioned in said first of said plurality of openings.

6. The arrangement defined in claim 5 wherein:
said second end of said first elongated dough member is formed into a spiral to define a third elongated dough member positioned in a second of said plurality of openings.

7. The arrangement defined in claim 5 wherein:
said second end of said first elongated dough member is formed into a spiral to define a third elongated dough member positioned in a second of said plurality of openings; and,
said first end of said first elongated dough member is further formed into a spiral to define a fourth elongated dough member positioned in said third of said plurality of openings.

8. The arrangement defined in claim 3 and further comprising:
said plurality of open spaces is three; and,
a third elongated dough member having said second preselected composition and formed into a spiral configuration and positioned within a second of said plurality of open spaces of said first elongated dough member.

9. The arrangement defined in claim 8 and further comprising:
a fourth elongated dough member having said second preselected composition and formed Into a spiral configuration and positioned within said third of said plurality of open spaces of said first elongated dough member.

10. A food product comprising, in combination:
a first elongated dough member having a first preselected composition and formed into a pretzel configuration having a plurality of open spaces between portions of the cylindrical dough, and said first elongated dough member having a first end and a second end, and said plurality of open spaces is three;
a second elongated dough member having a second preselected composition and formed into a spiral configuration and positioned within a first of said plurality of open spaces, of said first elongated dough member; and
a third elongated dough member having said second preselected composition and formed into a spiral configuration and positioned within a second of said plurality of open spaces of said first elongated dough member.
a fourth elongated dough member having said second preselected composition and formed into a spiral configuration and positioned within said third of said plurality of open spaces of said first elongated dough member.

11. A food product comprising, in combination:
a first elongated dough member having a first preselected composition and formed into a pretzel configuration having a plurality of open spaces between portions of the cylindrical dough, and said first elongated dough member having a first end and a second end; of open spaces is three;
a second elongated dough member having a second preselected composition and formed into a spiral configuration and positioned within a first of said plurality of open spaces of said first elongated dough member; and
a third elongated dough member having said first preselected composition and formed into a spiral configuration and positioned within a second of said plurality of open spaces of said first elongated dough member.

12. The arrangement defined in claim 11 and further comprising:
a fourth elongated dough member having one of said first and said second preselected compositions and formed into a spiral configuration and positioned within a third of said plurality of open spaces of said first elongated dough member.
